(19) United States
(12) Patent Application Publication
(10) Pub. No.: US 2026/0252245 A1
(43) Pub. Date: Aug. 27, 2026

(54) DATA PROCESSING SYSTEM INCLUDING MEMORY DEVICE, AND METHOD OF OPERATING THE SAME

(71) Applicant: SK hynix Inc., Gyeonggi-do (KR)

(72) Inventor: Kwang Sik SHIN, Gyeonggi-do (KR)

(21) Appl. No.: 19/324,141

(22) Filed: Sep. 10, 2025

(30) Foreign Application Priority Data
Feb. 24, 2025 (KR) 10-2025-0023790
Mar. 31, 2025 (KR) 10-2025-0041076

(51) Int. Cl. G06F 3/06

(52) U.S. Cl. CPC G06F 3/0625; G06F 3/0659; G06F 3/0673

(57) ABSTRACT

A data processing system includes a host; a first memory device communicating with the host via an interface; and a second memory device communicating with the first memory device via the interface, storing data used in a memory-intensive computation, and performing the memory-intensive computation instead of the first memory device.

### CROSS-REFERENCE TO RELATED APPLICATION

The present application claims priority under 35 U.S.C. § 119(a) to Korean patent application number 10-2025-0023790, filed on Feb. 24, 2025 and Korean patent application number 10-2025-0041076, filed on Mar. 31, 2025, the entire disclosures of which are incorporated herein by reference.

### BACKGROUND

### 1. Technical Field

Various embodiments of the present disclosure generally relate to a data processing system, and more particularly, to a data processing system and a method of operating the data processing system.

### 2. Related Art

With recent advances in large language models (LLMs) for multi-modal support, the size of contexts to be processed at one time is rapidly increasing. Compared to traditional text-based models, multi-modal models are characterized by the need to handle various types of data, which significantly increases the size of sequences for information representation. As a result, the context size of LLMs can increase.

While the increase in context size significantly increases the amount of information which LLMs can process, it also requires an increase in memory storage capacity. Therefore, there is a need for a data processing system which includes extended memory for efficient processing of LLMs and optimized performance.

### SUMMARY

Various embodiments of the present disclosure are directed to a data processing system including a memory device for storing data for memory-intensive computations and for performing the memory-intensive computations, and a method of operating the data processing system.

A data processing system according to embodiments of the present disclosure may include a host; a first memory device configured to communicate with the host via an interface; and a second memory device configured to communicate with the first memory device via the interface, storing data used in a memory-intensive computation, and performing the memory-intensive computation instead of the first memory device.

In an embodiment, the second memory device may include a computing circuit and a memory bank. The memory bank may store the data used in the memory-intensive computation. The computing circuit may perform the memory-intensive computation.

In an embodiment, the memory-intensive computation may be a part of an inference computation of generating an output corresponding to a received input based on knowledge learned by a language model.

In an embodiment, the data processing system may comprise the inference computation, the inference computation may comprise a plurality of computation units arranged sequentially. Each of the plurality of computation units may include an embedding layer, a plurality of decoder layers, and a head layer. Each of the plurality of decoder layers may include a multi-head attention block and a feed-forward block. The memory-intensive computation may include a matrix multiplication performed in the multi-head attention block.

In an embodiment, the memory bank may include a key cache and a value cache. The computing circuit may be configured to receive query data, first key data, and first value data from the first memory device, may be configured to generate third key data based on second key data stored in the key cache and the first key data, and may be configured to generate intermediate data by performing the matrix multiplication between the query data and the third key data.

In an embodiment, the second key data may be key data generated by a preceding computation unit in a sequence of the plurality of computation units, or key data generated by a preceding decoder layer in a sequence of the plurality of decoder layers.

In an embodiment, the computing circuit may be further configured to generate third value data based on second value data stored in the value cache and the first value data, may be further configured to generate a context vector by performing the matrix multiplication between the intermediate data and the third value data, and may be further configured to output the context vector to the first memory device.

In an embodiment, the second value data may be value data generated by a preceding computation unit in a sequence of the plurality of computation units, or value data generated by a preceding decoder layer in a sequence of the plurality of decoder layers.

In an embodiment, the computing circuit may be further configured to store the generated third key data in the key cache, and the generated third value data in the value cache.

In an embodiment, the first memory device may include a plurality of memory dies and a base die, the base die may include a controller which controls the plurality of memory dies, and the first memory device may be configured to communicate with the host and the second memory device via the base die.

In an embodiment, the second memory device may be configured as a single package in which the computing circuit and the memory bank are integrated.

In an embodiment, the host and the first memory device may be physically coupled via an interposer substrate, the first memory device and the second memory device may be physically coupled via a packaging substrate, the interposer substrate and the packaging substrate may be electrically connected via a connection terminal, and the interposer substrate may be disposed on the packaging substrate.

In an embodiment, the second memory device may be disposed at one of sides of the first memory device.

A data processing system according to embodiments of the present disclosure may include a first memory device processing an inference computation and a second memory device communicating with the first memory device, and a method of operating the data processing system may include receiving, by the second memory device, query data, first key data, and first value data from the first memory device; and generating, by the second memory device, a context vector by performing a memory-intensive computation based on data stored in the second memory device, the query data, the first key data, and the first value data.

In an embodiment, generating, by the second memory device, the context vector by performing the memory-intensive computation based on the data stored in the second memory device, the query data, the first key data, and the first value data may include generating, by the second memory device, third key data based on second key data stored in the second memory device, and the first key data; generating, by the second memory device, intermediate data by performing a matrix multiplication between the third key data and the query data; generating, by the second memory device, third value data based on second value data stored in the second memory device, and the first value data; and generating, by the second memory device, the context vector by performing the matrix multiplication between the intermediate data and the third value data.

In an embodiment, the method may further include outputting, by the second memory device, the context vector to the first memory device.

In an embodiment, the method may further include storing, by the first memory device, the context vector received from the second memory device; and performing, by the first memory device, a subsequent computation of the inference computation, wherein the subsequent computation includes processing the context vector to generate an output tensor.

In an embodiment, the method may further include receiving, by the first memory device, weight matrices and an input tensor from a host; receiving, by the first memory device, the query data, the first key data, and the first value data generated based on the weight matrices and the input tensor from the host; and outputting, by the first memory device, the query data, the first key data, and the first value data to the second memory device.

In an embodiment, the first memory device may include a plurality of memory dies and a base die, and the base die may include a controller which controls the plurality of memory dies. The second memory device may receive the query data, the first key data, and the first value data from the first memory device via the base die, and may output the context vector to the first memory device via the base die.

In an embodiment, the second memory device may be configured as a single package in which a computing circuit and a memory bank are integrated.

### BRIEF DESCRIPTION OF THE DRAWINGS

FIG. 1 is a block diagram illustrating an electronic device according to an embodiment of the present disclosure;

FIG. 2 is a block diagram illustrating a data processing system according to an embodiment of the present disclosure;

FIG. 3 is a diagram illustrating an inference computation model processed in a data processing system;

FIG. 4 is a diagram illustrating a multi-head attention block;

FIG. 5 is a diagram of a self-attention operation according to an embodiment of the present disclosure;

FIG. 6 is a diagram illustrating a self-attention operation according to an embodiment of the present disclosure; and

FIG. 7 is a block diagram illustrating an electronic device according to an embodiment of the present disclosure.

### DETAILED DESCRIPTION

Hereinafter, embodiments according to the present disclosure are described in detail with reference to the accompanying drawings. It should be noted that in the following description, only portions necessary for understanding an operation according to the present disclosure may be described, and descriptions of other portions may be omitted in order not to obscure the subject matter of the present disclosure. In addition, the embodiments of the present disclosure may be embodied in other forms without being limited to embodiments described herein. However, embodiments of the present disclosure are described in detail in order for those skilled in the art to be able to readily implement the technical spirit of the present disclosure.

Terms used herein are for describing specific embodiments and are not intended to limit the embodiments. Throughout the specification, in a case where a certain portion “includes” a certain component, the portion may further include another component without excluding another component unless otherwise stated. “At least any one of X, Y, or Z” and “at least any one selected from a group consisting of X, Y, or Z” may be interpreted as X only, Y only, Z only, or any combination of two or more of X, Y, and Z (e.g., XYZ, XYY, YZ, and ZZ). Here, “and/or” includes all combinations of one or more of corresponding configurations.

Terms such as first and second may be used to describe various components, but these components are not limited to these terms. These terms are used to distinguish one component from another component. Therefore, a first component may refer to a second component within a range without departing from the scope disclosed herein.

In the present disclosure, some embodiments are described and illustrated in the accompanying drawings in terms of functional blocks, units, parts, and/or modules. Those skilled in the art will understand that these blocks, units, parts, and/or modules are physically implemented by electronic (or optical) circuits, such as logic circuits, discrete components, microprocessors, hard-wired circuits, memory elements, line connections, and the like, which may be formed using semiconductor-based manufacturing techniques or other manufacturing techniques. In a case where the blocks, units, parts, and/or modules are implemented by microprocessors or other similar hardware, they may be programmed and controlled using software (e.g., microcode) to perform the various functions discussed herein and may optionally be driven by firmware and/or software.

Further, each block, unit, part, and/or module may be implemented by dedicated hardware, or by a combination of dedicated hardware performing some functions and processors (e.g., one or more programmed microprocessors and associated circuits) performing other functions. Further, each block, unit, part, and/or module of some embodiments may be physically separated into two or more interacting and separate blocks, units, parts, and/or modules without departing from the scope of the present disclosure. Further, the blocks, units, parts, and/or modules of some embodiments may be physically combined into more complex blocks, units, parts, and/or modules without departing from the scope of the present disclosure.

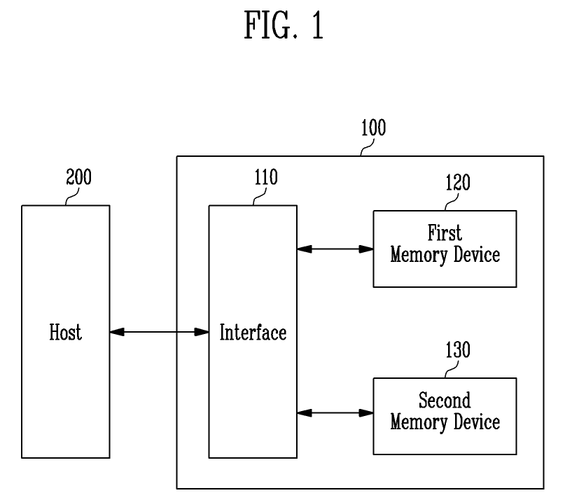

FIG. 1 is a block diagram illustrating an electronic device 10 according to an embodiment of the present disclosure.

Referring to FIG. 1, the electronic device 10 may include a data processing system 100 and a host 200.

The electronic device 10 may be any electronic device, such as a personal computer, a server computer, a mobile computing device, an electronic control unit of an automobile, and the like.

In an embodiment, the electronic device 10 may be implemented as a large language model (LLM), a data server, a cloud system, an artificial intelligence server, a network-attached storage (NAS), an Internet of Things (IoT) device, a personal computer (PC), or a portable electronic device.

The data processing system 100 may process (compute) corresponding operations in response to requests and addresses from the host 200 and, if necessary, transfer data resulting from the processing to the host 200. In an embodiment, the data processing system 100 may implement a language model to learn data and to understand and generate language based on the data. The language model implemented in the data processing system 100 may include a learning process and an inference process.

The data processing system 100 may include an interface 110, a first memory device 120, and a second memory device 130.

The first memory device 120 and the second memory device 130 may communicate with the host 200 via the interface 110. The first memory device 120 and the second memory device 130 may store data or output stored data in response to commands received from the host 200.

In an embodiment, each of the first memory device 120 and the second memory device 130 may be a volatile memory device. For example, the volatile memory device may include dynamic random access memory (DRAM) and/or static random access memory (SRAM).

Each of the first memory device 120 and the second memory device 130 may include a memory bank. The memory bank may include a plurality of memory cells which are connected between a word line and a bit line. For example, memory cells connected to one word line may form one page.

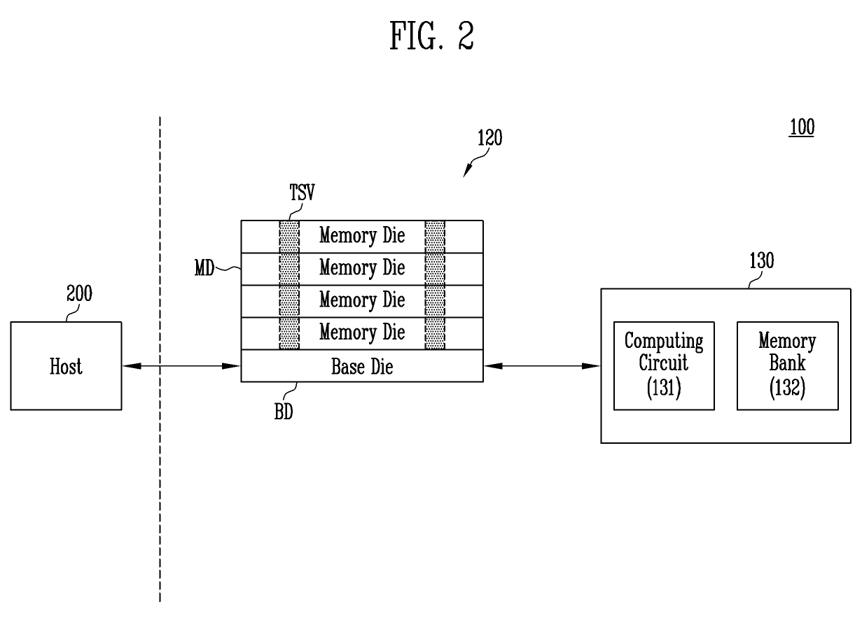

In an embodiment, the first memory device 120 may be implemented as one of a high bandwidth memory (HBM) device, a double data rate dynamic random access memory (DDR DRAM) device, and a low power double data rate dynamic random access memory (LPDDR DRAM) device. When the first memory device 120 is configured as an HBM device including a base die and a plurality of memory dies, the interface 110 may be configured as a base die. A more detailed description of this will be provided below with reference to FIG. 2.

When the interface 110 is configured as a base die for the first memory device 120, a controller controlling the first memory device 120 may be included in the interface 110. The interface 110 may store data in a memory bank of the first memory device 120, or read data stored in the memory bank, in response to a command received from the host 200.

In an embodiment, the first memory device 120 may store data used in an inference computation. The host 200 may perform an inference computation via the interface 110 and the first memory device 120. For example, an inference computation may be a process of generating an output which corresponds to a received input based on the knowledge learned by the language model. An inference computation may be actual calculations or predictions made by the model in response to a given question or command.

As technology advances, the volume of specific data (e.g., key data, value data) which is only used in memory-intensive computations during inference computations may increase. Accordingly, the data processing system 100 may require memory devices other than the first memory device 120 to store the specific data. As the volume of the specific data increases, the memory devices other than the first memory device 120 may be implemented as high bandwidth memory devices to receive the specific data from the first memory device 120.

However, when the memory devices other than the first memory device 120 are implemented as high bandwidth memory devices, the cost of the data processing system 100 may increase. When the capacity of the first memory device 120 is increased to store the specific data, the manufacturing complexity of the first memory device 120 may increase, and the thermal management of the first memory device 120 may be difficult.

Furthermore, because the language model executed by the data processing system 100 is a service targeted to a user, it may be important to deliver processed results to the user quickly, which may require a memory device which stores specific data while having a short data transfer distance from the first memory device 120.

In an embodiment, the second memory device 130 may be configured as a Processor In Memory (PIM). When the second memory device 130 is configured as a PIM, the second memory device 130 may include a computing circuit and a memory bank. The second memory device 130 may be configured as a single package in which the computing circuit and the memory bank are integrated.

Further, in an embodiment, the second memory device 130 may include DRAM cells, such as LPDDR DRAM cells and DDR DRAM cells, and may include computational logic disposed in physical proximity to the DRAM cells. In another embodiment, the second memory device 130 may include DRAM cells, such as LPDDR DRAM cells and DDR DRAM cells, and may utilize the analog characteristics of the DRAM cells to perform computations.

Hereinafter, the computing circuit of the second memory device 130 may refer to the computational logic disposed near the DRAM cells or a circuit which supports computations utilizing the analog characteristics of the DRAM cells. The memory bank of the second memory device 130 may include DRAM cells.

The second memory device 130 may perform memory-intensive computations during inference computations using the computing circuit. By performing memory-intensive computations, the second memory device 130 may generate specific data. Because the second memory device 130 generates and stores the specific data, the first memory device 120 might not transfer or receive the specific data to or from the second memory device 130.

Instead, the first memory device 120 may send input data to the second memory device 130 which is required for the second memory device 130 to perform a memory-intensive computation, or receive result data from the second memory device 130 which is the result of the memory-intensive computation. The input data and result data may have a smaller volume than the specific data. Even when the second memory device 130 is not implemented as a high bandwidth memory device, the second memory device 130 may store the specific data instead of the first memory device 120.

Accordingly, the cost of the data processing system 100 may be reduced and the thermal management may be facilitated compared to increasing the capacity of the first memory device 120 to store the specific data.

Further, because the second memory device 130 communicates with the first memory device 120 via the interface 110, the data transfer distance may be short. Accordingly, even though the second memory device 130 performs some of the inference calculations, the speed of performing the inference calculations might not be significantly reduced.

The host 200 may transfer requests and addresses related to data processing to the data processing system 100, and if necessary, data, and receive processing results thereof. The host 200 may request data input or output to the data processing system 100, or may request that the data processing system 100 process (execute) an application which involves data input or output. In an embodiment, the host 200 may be implemented as a central processing unit (CPU) or a graphics processing unit (GPU).

FIG. 2 is a block diagram illustrating the data processing system 100 according to an embodiment of the present disclosure.

Referring to FIG. 2, the first memory device 120 may include a plurality of memory dies MD and a base die BD, and the second memory device 130 may include a computing circuit 131 and a memory bank 132.

The data processing system 100 and the host 200 of FIG. 1 are similar to the data processing system 100 and the host 200 of FIG. 2, so that repetitive descriptions may be omitted. Further, the interface 110 of FIG. 1 may be implemented as the base die BD of the first memory device 120.

The first memory device 120 may have a stacked structure of the plurality of memory dies MD and the base die BD. The plurality of memory dies MD may be stacked on the base die BD and may be coupled to each other via a through-silicon via TSV. In each of the plurality of memory dies MD, memory cells for storing data and circuits for operating the memory cells may be disposed.

The plurality of memory dies MD may be electrically connected to the base die BD via the through-silicon via TSV, and may receive signals and power from the base die BD via the through-silicon via TSV.

The base die BD may include a controller which controls the plurality of memory dies MD. The base die BD may include a circuit for communication between the plurality of memory dies MD and the host 200. The base die BD may also include a circuit for communication between the second memory device 130 and the host 200.

The second memory device 130 may receive commands from the host 200 via the base die BD, or may receive data stored in the first memory device 120 via the base die BD. The computing circuit 131 may perform memory-intensive computations based on the data stored in the memory bank 132. The memory bank 132 may store specific data which is only used in the memory-intensive computations during inference computations.

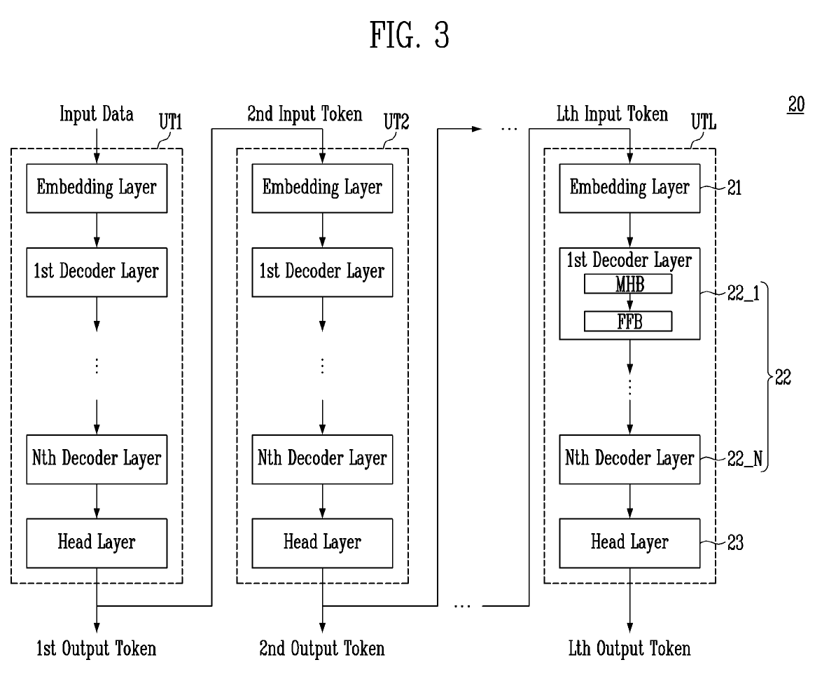

FIG. 3 is a diagram illustrating an inference computation model 20 included in the data processing system 100.

Referring to FIG. 3, the data processing system 100 may generate an output token by applying the inference computation model 20 to input data.

The data processing system 100 may generate the output token by iteratively applying a computation unit to the input data. Referring to FIG. 3, the inference computation model 20 is shown to include a plurality of computation units UT1 to UTL, but this is intended to represent the chronological order in which the computation unit is iteratively applied, as will be understood by those of ordinary skill in the art. L is a natural number greater than 1. In this regard, the plurality of computation units UT1 to UTL may be arranged in a sequence, where each computation unit is sequentially applied to an output token generated by a preceding computation unit.

For example, the first computation unit UT1 may be a computation unit first applied to the input data, and the second computation unit UT2 may be a computation unit applied to a first output token generated by the application of the computation unit to the input data. The inference computation model 20 may be performed by a plurality of computation units.

Each of the plurality of computation units UT1 to UTL may be divided into a summarization phase and a generation phase. In the summarization phase, the data processing system 100 may tokenize the input data into one or more input tokens and perform the inference computation model 20 on the generated input tokens. The inference computation model 20 may predict an output token corresponding to the input tokens. In the summarization phase, computations on one or more tokens may be processed in parallel. For example, in the first computation unit UT1 of FIG. 3, computations on one or more first input tokens may be performed in parallel to generate a first output token.

In the generation phase, the inference computation model 20 may be provided with an output token generated in a preceding computation unit as an input token. For example, the second computation unit UT2 may be provided with the first output token generated in the first computation unit UT1 as a second input token. The inference computation model 20 may predict a second output token corresponding to a sequence of the first input token and the second input token. Accordingly, each computation unit may generate key data and/or value data, and such key data may be used by a subsequent computation unit arranged later in the sequence of the plurality of computation units.

The generation phase may be iterated until an output token generated in a specific computation unit satisfies a predetermined termination criterion. For example, the generation phase may be iterated until an output token corresponding to a predefined special token is generated. In another embodiment, the generation phase may be iterated until a predefined number of output tokens are generated.

Each of the plurality of computation units UT1 to UTL may include an embedding layer 21, a plurality of decoder layers 22, and a head layer 23. The data processing system 100 may sequentially apply the embedding layer 21, the plurality of decoder layers 22, and the head layer 23 to the input token.

The embedding layer 21 may map the input data or the input token to a high-dimensional vector space, and convert the input data or the input token to a dense vector of real numbers in a latent space. During this process, each token is represented by a unique vector value, which may contain semantic information learned by the model.

A first decoder layer 22_1 may process embeddings calculated by the embedding layer 21 as input, and remaining decoder layers 22_2 to 22_N other than the first decoder layer 22_1 may process output of a preceding decoder layer as input. N is a natural number greater than 1. In an embodiment, each decoder layer may generate key data based on its input, and the input may include output data from a preceding decoder layer. Likewise, in the sequence of the plurality of computation units, each computation unit may generate key data based on data processed in a preceding computation unit.

The first decoder layer 22_1 may include a multi-head attention block MHB and a feed-forward block FFB. FIG. 3 illustrates that only the first decoder layer 22_1 includes the multi-head attention block MHB and the feed-forward block FFB, but the other decoder layers 22_2 to 22_N shown in FIG. 3 may also include the multi-head attention block MHB and the feed-forward block FFB similar to the first decoder layer 22_1.

The multi-head attention block MHB may perform a multi-head attention computation on a sequence of input tokens. For example, in the M-th computation unit, the multi-head attention block MHB of the first decoder layer 22_1 may perform a multi-head attention computation using query data calculated from the embedding layer 21 of an M-th input token and key-value sets calculated from a sequence of embedding layers (i.e., the embedding layers of the first to M-th input tokens).

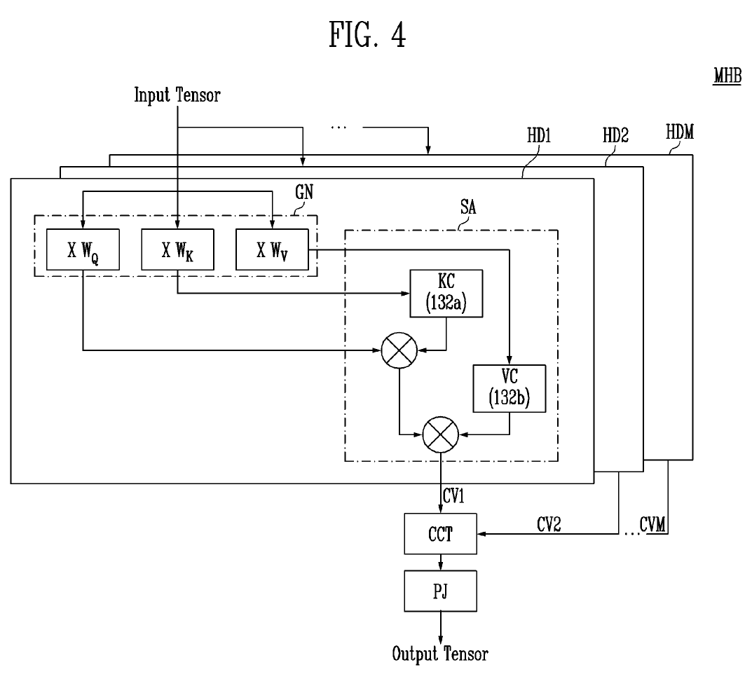

The key-value sets may be stored in the second memory device 130 of FIG. 2 to prevent a duplicate computation of the same key-value set among the plurality of computation units. The multi-head attention block MHB will be described in more detail with reference to FIG. 4.

The feed-forward block FFB may perform a nonlinear transformation on a tensor received from the multi-head attention block MHB and pass the result back to the inference computation model 20. In an embodiment, the feed-forward block FFB may be a Fully-Connected Neural Network with one hidden layer.

The head layer 23 may utilize an output tensor of the last decoder layer 22_N to generate an output token for a current computation unit. For example, the head layer 23 may calculate a probability value for each token within a predefined set of tokens and output an identifier for the token with the highest probability.

As shown in FIG. 3, the plurality of computation units UT1 to UTL are sequentially arranged such that the output of a preceding computation unit is used as input for a subsequent computation unit. Each computation unit includes the plurality of decoder layers 22, which are also arranged in sequence.

FIG. 4 is a diagram illustrating the multi-head attention block MHB.

Referring to FIG. 4, operations of generating query data, key data, and value data in the multi-head attention block MHB of FIG. 3, and performing attention computations on the generated query data, key data, and value data are described.

The operations of the multi-head attention block MHB described with reference to FIG. 4 will be described based on the computation unit performed in the generation phase of FIG. 3. The operation described with reference to FIG. 4 may be the operation of the multi-head attention block MHB in a state in which a prefill result of input data is stored in the memory bank 132 of the second memory device 130.

Referring to FIG. 4, the multi-head attention block MHB may include a plurality of attention heads HD1 to HDM. Each of the plurality of attention heads HD1 to HDM may receive an input tensor.

The plurality of attention heads HD1 to HDM may include different weight matrices. For example, a query weight matrix W_{Q}, a key weight matrix W_{K}, and a value weight matrix W_{V} of the first attention head HD1 may be different from the query weight matrix W_{Q}, the key weight matrix W_{K}, and the value weight matrix W_{V} of the second attention head HD2. M is a natural number greater than 1.

Each of the plurality of attention heads HD1 to HDM may generate query data, key data, and value data corresponding to the input tensor through its own weight matrices, and perform a self-attention computation on the generated query data, key data, and value data.

Hereinafter, operations are described with a focus on the first attention head HD1 of the plurality of attention heads HD1 to HDM, and all the plurality of attention heads HD1 to HDM may operate similarly to the first attention head HD1.

The first attention head HD1 may perform a generation computation GN and a self-attention computation SA.

In the generation computation GN, the first attention head HD1 may generate query data, key data, and value data corresponding to the input tensor by performing a matrix multiplication between the input tensor and the query weight matrix W_{Q}, the key weight matrix W_{K}, and the value weight matrix W_{V}, respectively. The query data, key data, and value data may be in the form of tensors.

The query data may be a vector of a token which the inference computation model is currently processing. The key data may be data which is compared to the query data to calculate similarity. The value data may be data where the inference computation model expresses all the relevance among words or tokens in a sentence.

The input tensor may be an embedding tensor output from the embedding layer 21 of the current computation unit, or an output tensor from a preceding decoder layer.

In an embodiment, the first attention head HD1 may perform the generation computation GN via the first memory device 120. The first memory device 120 may output generated query data, first key data, and first value data to the second memory device 130.

The first attention head HD1 may perform the self-attention computation SA via the second memory device 130. The second memory device 130 may generate third key data for the self-attention computation SA based on the first key data generated and received from the current decoder layer and second key data stored in the second memory device 130. The third key data may be a tensor including the first key data and the second key data.

In an embodiment, the second key data stored in the second memory device 130 may be key data generated in a preceding computation unit or key data generated in a preceding decoder layer.

The second memory device 130 may store the first key data generated and received from the current decoder layer in a key cache 132a. The second memory device 130 may generate the third key data based on the second key data and the first key data stored in the key cache 132a.

The third key data generated in the current decoder layer may be stored in the key cache 132a. The third key data generated in the current decoder layer may serve as the second key data in a next decoder layer, that is, the second memory device 130 may generate the third key data upon receiving the first key data, and update the second key data stored in the key cache 132a with the third key data.

The second memory device 130 may generate intermediate data by performing a matrix multiplication between the third key data and the query data generated and received from the current decoder layer.

The second memory device 130 may generate third value data for the self-attention computation SA based on the first value data generated and received in the current decoder layer and second value data stored in the second memory device 130. The third value data may be a tensor including the first value data and the second value data.

In an embodiment, the second value data stored in the second memory device 130 may be value data generated by a preceding computation unit.

The second memory device 130 may store the first value data generated and received from the current decoder layer in a value cache 132b. The second memory device 130 may generate the third value data based on the second value data generated in the preceding decoder layer and stored in the value cache 132b, and the first value data.

The third value data generated in the current decoder layer may be stored in the value cache 132b. The third value data generated in the current decoder layer may serve as the second value data in the next decoder layer, that is, the second memory device 130 may generate the third value data upon receiving the first value data, and update the second value data stored in the value cache 132b with the third value data.

The key cache 132a and the value cache 132b shown in FIG. 4 may be included in the memory bank 132 shown in FIG. 2. While the key cache 132a and the value cache 132b are shown as being separate from each other in FIG. 4, this is for illustrative purposes only, and the key cache 132a and the value cache 132b might not be separate from each other according to embodiments.

The second memory device 130 may generate a first context vector CV1 by performing a matrix multiplication between the intermediate data and the third value data. The first context vector CV1 may be the result of the self-attention computation of the first attention head HD1.

The second memory device 130 may output the first context vector CV1 to the first memory device 120. Similarly, each of the plurality of attention heads HD1 to HDM may output a generated context vector to the first memory device 120.

The first memory device 120 may offload the self-attention computation SA during the inference computation to the second memory device 130, and the second memory device 130 may perform the self-attention computation SA instead of the first memory device 120.

The plurality of attention heads HD1 to HDM may generate a plurality of context vectors CV1 to CVM. The multi-head attention block MHB may perform a concatenate computation CCT on the plurality of context vectors CVb to CVM via the first memory device 120. The multi-head attention block MHB may concatenate the plurality of context vectors CV1 to CVM output from the plurality of attention heads HD1 to HDM to create a single large vector.

The multi-head attention block MHB may perform a linear transformation computation PJ on the concatenated vectors to generate an output tensor. The multi-head attention block MHB may use a weight matrix to transform the concatenated vectors into vectors of different dimensions, and generate the output tensor.

As described with reference to FIG. 4, by allowing the second memory device 130 to perform the self-attention computation SA instead of the first memory device 120 as an extension of the first memory device 120, the number of tasks the first memory device 120 can process simultaneously may be increased, and the time for the first memory device 120 to perform the inference computation may be reduced. Accordingly, more tasks may be processed simultaneously while reducing the processing time for individual tasks.

As the second memory device 130 performs the self-attention computation SA via the computing circuit 131 of FIG. 2, and as the memory bank 132 of FIG. 2 includes the key cache 132a and the value cache 132b, the second memory device 130 may generate the third key data and the third value data by directly performing a memory-intensive computation. Because the second memory device 130 generates and stores the third key data and the third value data, there may be no need to transfer and receive the third key data and the third value data between the first memory device 120 and the second memory device 130.

Accordingly, even when the second memory device 130 is not implemented as a high bandwidth memory device, the second memory device 130 may store specific data instead of the first memory device 120. Further, compared to increasing the capacity of the first memory device 120 (e.g., by expanding a memory die stack of the first memory device 120) to store the specific data, the cost of the data processing system 100 may be reduced, the power consumption of the data processing system 100 may be reduced, and the thermal management of the data processing system 100 may be facilitated.

Because the second memory device 130 receives the query data, the first key data, and the first value data from the first memory device 120 via the interface 110, and the second memory device 130 outputs the first context vector CV1 to the first memory device 120 via the interface 110, a data transfer distance may be short. Accordingly, even when the second memory device 130 performs the self-attention computation during the inference computation instead of the first memory device 120, the speed of performing the inference computation might not be significantly reduced.

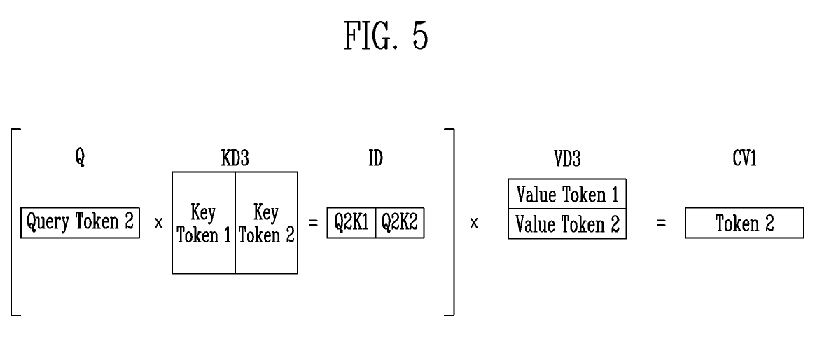

FIG. 5 is a diagram of a self-attention operation according to an embodiment of the present disclosure.

Referring to FIG. 5, an operation in which the first attention head HD1 of FIG. 4 performs the self-attention computation SA via the second memory device 130 of FIG. 2 is illustrated.

In FIG. 5, the operation is described based on the case where the second memory device 130 receives a second query token as the query data of FIG. 4, a second key token as the first key data of FIG. 4, and a second value token as the first value data of FIG. 4 from the first memory device 120.

Further, in FIG. 5, the operation is described based on the case where the second memory device 130 stores a first key token as the second key data of FIG. 4 and a first value token as the second value data of FIG. 4.

The second memory device 130 may receive the second query token, the second key token, and the second value token from the first memory device 120.

The second memory device 130 may generate third key data KD3 based on the first key token stored in the key cache 132a and the second key token received from the first memory device 120. The third key data KD3 may be a tensor generated by merging the first key token and the second key token.

The second memory device 130 may perform a matrix multiplication between query data Q and the third key data KD3 to generate intermediate data ID.

The second memory device 130 may generate third value data VD3 based on the first value token stored in the value cache 132b and the second value token received from the first memory device 120. The third value data VD3 may be a tensor generated by merging the first value token and the second value token.

The second memory device 130 may perform a matrix multiplication between the intermediate data ID and the third value data VD3 to generate the first context vector CV1 for the current decoder layer.

The second memory device 130 may output the first context vector CV1 to the first memory device 120. Referring to FIG. 4, the first memory device 120 may apply the feed-forward block FFB after performing the concatenate computation CCT and the linear transformation computation PJ on the plurality of received context vectors CV1 to CVM.

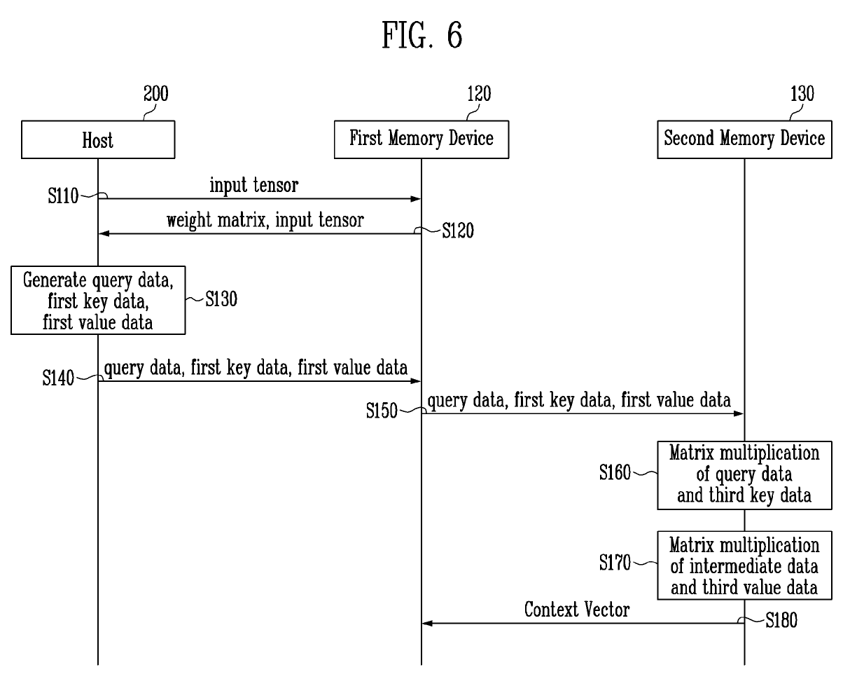

FIG. 6 is a diagram illustrating a self-attention operation according to an embodiment of the present disclosure.

Referring to FIG. 6, a self-attention operation performed in the data processing system 100 including the host 200, the first memory device 120, and the second memory device 130 of FIG. 2 is illustrated. While the self-attention operation is illustrated in FIG. 6 for ease of description, embodiments of the present disclosure allow a plurality of attention heads to perform self-attention operations in parallel.

At operation S110, the host 200 may output an input tensor to the first memory device 120.

At operation S120, the first memory device 120 may output weight matrices and the input tensor to the host 200. The weight matrices may include the query weight matrix WQ, the key weight matrix WK, and the value weight matrix WV of FIG. 4. In some embodiments, the query weight matrix WQ, the key weight matrix WK, and the value weight matrix W_{V} may be data stored by the host 200 in the first memory device 120 prior to operation S110.

At operation S130, the host 200 may generate query data, first key data, and first value data based on the weight matrices and the input tensor.

In an embodiment, operations S120 and S130 may be a process in which the host 200 loads the weight matrices and input tensor stored in the first memory device 120 into internal memory to generate the query data, the first key data, and the first value data. Some of the data generated during this computational process may be stored in the first memory device 120 and provided to the host 200.

At operation S140, the host 200 may output the query data, the first key data, and the first value data to the first memory device 120.

At operation S150, the first memory device 120 may output the query data, the first key data, and the first value data to the second memory device 130. In an embodiment, the first memory device 120 may output the query data, the first key data, and the first value data to the second memory device 130 via the base die BD of FIG. 2.

At operation S160, the second memory device 130 may perform a matrix multiplication between the query data and third key data to generate intermediate data. In an embodiment, the second memory device 130 may generate the third key data based on the first key data generated and received from the current decoder layer and second key data stored in the key cache 132a.

At operation S170, the second memory device 130 may perform a matrix multiplication between the intermediate data and third value data to generate a context vector. In an embodiment, the second memory device 130 may generate the third value data based on the first value data generated and received from the current decoder layer and second value data stored in the value cache 132b.

At operation S180, the second memory device 130 may output a context vector to the first memory device 120. In an embodiment, the second memory device 130 may output the context vector to the first memory device 120 via the base die BD of FIG. 2. The context vector may be stored in the first memory device 120 and used in subsequent computations of an inference computation. The subsequent computation may include processing the context vector to generate an output tensor. For example, the subsequent computation may include the concatenate computation or the linear transformation computation.

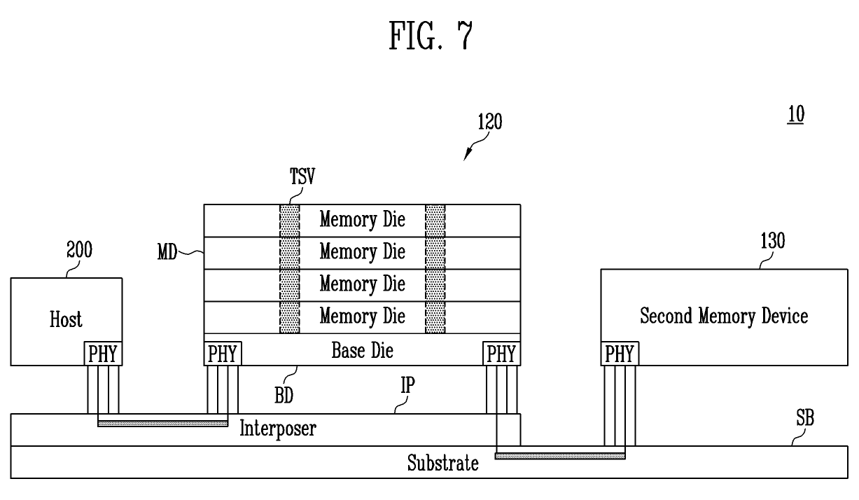

FIG. 7 is a block diagram illustrating the electronic device 10 according to an embodiment of the present disclosure.

Referring to FIGS. 2 and 7, the first memory device 120 may communicate with the host 200 and the second memory device 130 via the base die BD.

The first memory device 120, the second memory device 130, and the host 200 in FIG. 7 are similar to the first memory device 120, the second memory device 130, and the host 200 in FIG. 2, thus, repetitive descriptions may be omitted.

The electronic device 10 may include the first memory device 120, the second memory device 130, and the host 200. The electronic device 10 may also include an interposer substrate IP for physically connecting the host 200 and the first memory device 120, and a packaging substrate SB for physically connecting the first memory device 120 and the second memory device 130.

The base die BD may include a circuit for a communication interface between the memory die MD and the host 200. The interposer substrate IP may couple the base die BD to the host 200 via a physical region PHY of each of the base die BD and the host 200.

The packaging substrate SB and the interposer substrate IP may be electrically connected via a connection terminal. The packaging substrate SB may couple the first memory device 120 to the second memory device 130 via the physical region PHY of each of the first memory device 120 and the second memory device 130. The interposer substrate IP may be disposed on the packaging substrate SB.

While the electronic device 10 shown in FIG. 7 is one embodiment, the present disclosure is not limited thereto, and the physical coupling relationship between the host 200, the first memory device 120, and the second memory device 130 may vary in different embodiments.

For example, in FIG. 7, it is illustrated that the second memory device 130 is disposed at a side of the first memory device 120 opposite a side at which the host 200 is located, but depending on embodiments, the second memory device 130 may be disposed on any of sides of the first memory device 120.

The embodiments disclosed herein are illustrative of the technical spirit of the present disclosure, not limiting the technical spirit of the present disclosure, and the scope of the technical spirit of the present disclosure is not limited by these embodiments. The scope of protection of this disclosure shall be construed by the appended claims, and all technical spirits within an equivalent scope shall be construed to be included within the scope of this disclosure. Furthermore, the embodiments may be combined to for additional embodiments.

According to some embodiments of the present disclosure, a memory device which facilitates the thermal management, reduces the power consumption, and reduces the cost, and a data processing system including the memory device are provided.

What is claimed is:

1. A data processing system comprising:
a host;
a first memory device configured to communicate with the host via an interface; and
a second memory device configured to communicate with the first memory device via the interface, store data used in a memory-intensive computation, and perform the memory-intensive computation instead of the first memory device.

2. The data processing system of claim 1,
wherein the second memory device includes a computing circuit and a memory bank,
wherein the memory bank stores the data used in the memory-intensive computation, and
wherein the computing circuit performs the memory-intensive computation.

3. The data processing system of claim 2, wherein the memory-intensive computation is a part of an inference computation of generating an output corresponding to a received input based on knowledge learned by a language model.

4. The data processing system of claim 3,
wherein the data processing system comprises the inference computation model,
wherein the inference computation comprises a plurality of computation units arranged sequentially,
wherein each of the plurality of computation units includes an embedding layer, a plurality of decoder layers, and a head layer,
wherein each of the plurality of decoder layers includes a multi-head attention block and a feed-forward block, and
wherein the memory-intensive computation includes a matrix multiplication performed in the multi-head attention block.

5. The data processing system of claim 4,
wherein the memory bank includes a key cache and a value cache, and
wherein the computing circuit is configured to:
receive query data, first key data, and first value data from the first memory device;
generate third key data based on second key data stored in the key cache and the first key data; and
generate intermediate data by performing the matrix multiplication between the query data and the third key data.

6. The data processing system of claim 5, wherein the second key data is key data generated by a preceding computation unit in a sequence of the plurality of computation units, or key data generated by a preceding decoder layer in a sequence of the plurality of decoder layers.

7. The data processing system of claim 5, wherein the computing circuit is further configured to:
generate third value data based on second value data stored in the value cache and the first value data;
generate a context vector by performing the matrix multiplication between the intermediate data and the third value data; and
output the context vector to the first memory device.

8. The data processing system of claim 7, wherein the second value data is value data generated by a preceding computation unit in a sequence of the plurality of computation units, or value data generated by a preceding decoder layer in a sequence of the plurality of decoder layers.

9. The data processing system of claim 7, wherein the computing circuit is further configured to store the generated third key data in the key cache, and the generated third value data in the value cache.

10. The data processing system of claim 9,
wherein the first memory device includes a plurality of memory dies and a base die, the base die including a controller which controls the plurality of memory dies, and
wherein the first memory device is configured to communicate with the host and the second memory device via the base die.

11. The data processing system of claim 10, wherein the second memory device is configured as a single package in which the computing circuit and the memory bank are integrated.

12. The data processing system of claim 11,
wherein the host and the first memory device are physically coupled via an interposer substrate,
wherein the first memory device and the second memory device are physically coupled via a packaging substrate,
wherein the interposer substrate and the packaging substrate are electrically connected via a connection terminal, and
wherein the interposer substrate is disposed on the packaging substrate.

13. The data processing system of claim 12, wherein the second memory device is disposed at one of sides of the first memory device.

14. A method of operating a data processing system which includes a first memory device processing an inference computation and a second memory device communicating with the first memory device, the method comprising:
receiving, by the second memory device, query data, first key data, and first value data from the first memory device; and
generating, by the second memory device, a context vector by performing a memory-intensive computation based on data stored in the second memory device, the query data, the first key data, and the first value data.

15. The method of claim 14, wherein generating, by the second memory device, the context vector by performing the memory-intensive computation based on the data stored in the second memory device, the query data, the first key data, and the first value data comprises:
generating, by the second memory device, third key data based on second key data stored in the second memory device, and the first key data;
generating, by the second memory device, intermediate data by performing a matrix multiplication between the third key data and the query data;
generating, by the second memory device, third value data based on second value data stored in the second memory device, and the first value data; and
generating, by the second memory device, the context vector by performing the matrix multiplication between the intermediate data and the third value data.

16. The method of claim 15, further comprising outputting, by the second memory device, the context vector to the first memory device.

17. The method of claim 16, further comprising:
storing, by the first memory device, the context vector received from the second memory device; and
performing, by the first memory device, a subsequent computation of the inference computation,
wherein the subsequent computation includes processing the context vector to generate an output tensor.

18. The method of claim 17, further comprising:
receiving, by the first memory device, weight matrices and an input tensor from a host;
receiving, by the first memory device, the query data, the first key data, and the first value data generated based on the weight matrices and the input tensor from the host; and
outputting, by the first memory device, the query data, the first key data, and the first value data to the second memory device.

19. The method of claim 17, wherein the first memory device includes a plurality of memory dies and a base die, the base die including a controller which controls the plurality of memory dies, and
wherein the second memory device receives the query data, the first key data, and the first value data from the first memory device via the base die, and outputs the context vector to the first memory device via the base die.

20. The method of claim 19, wherein the second memory device is configured as a single package in which a computing circuit and a memory bank are integrated.
